(19) United States
(12) Patent Application Publication
(10) Pub. No.: US 2006/0032116 A1
(43) Pub. Date: Feb. 16, 2006

(54) Garden weed barrier and watering system

(76) Inventor: James M Milliken, Saint Francis, KS (US)

Correspondence Address: ERICKSON & KLEYPAS, L.L.C., 800 W. 47TH STREET, SUITE 401, KANSAS CITY, MO, 64112, US

(21) Appl. No.: 10/541,294

(22) PCT Filed: Dec. 30, 2003
(86) PCT No.: PCT/US03/41627

§ 371 Date: Jun. 30, 2005

Related U.S. Application Data
(60) Provisional application No. 60/437,486, filed on Dec. 31, 2002.

(51) Int. Cl. A01G 13/02

(52) U.S. Cl. 47/21.1; 47/31.1

(57) ABSTRACT

A garden weed barrier and watering apparatus including a flexible sheet of vapor-permeable material having reinforced, weighted edges to secure the sheet to the ground, openings in the sheet to receive garden plants, and a tube secured to the bottom of the sheet for delivering fluid to the plants.

### CROSS REFERENCE TO RELATED APPLICATION

This application claims the benefit of the prior filed, co-pending provisional application, Ser. No. 60/437,486, filed Dec. 31, 2002 with the United States Patent and Trademark Office.

### FIELD OF THE INVENTION

The present invention is in the field of devices for gardening, and more particularly in the field of systems for suppressing weeds and delivering water to plants.

### BACKGROUND OF THE INVENTION

Ground or landscape cloths have been used for many years to control weeds and stabilize tilled soil. When used in gardens these devices greatly reduce maintenance otherwise required to prevent overgrowth of weeds and soil erosion. It is known to lay soaker-hoses on top of landscape cloths as a way of watering large gardens by simply turning on the water supply. Since landscape cloths are typically porous, water applied to the top surface seeps through and wets the soil below. Depending on the porosity of the cloth, however, water can pool during watering leading to uneven distribution. In addition, since the hose is simply laid on top of the fabric, it is subject to dislocation by wind, heavy rain or animals such as dogs. It may also move by expansion and contraction due to temperature changes.

The cloth itself is also subject to dislocation, particularly by wind, and often large sections of cloth are folded over exposing the ground beneath, permitting weeds to germinate and grow. Sometimes gardeners attempt to hold the cloth in place by covering the outer edges with soil. Rain often washes this soil away, however, and the fabric may then be dislocated. To solve this problem, gardeners often will use stakes or two-pronged staples to secure the cloth to the ground.

These methods are quite labor intensive, particularly with large gardens, since it requires placement of a staple every few inches along all sides of each cloth or covering all sides of the cloth with soil. Typically, if staples are used they are simply forced through the fabric of the cloth, making tears and holes. Over time these holes can enlarge causing gaps between the cloth and ground allowing sunlight to penetrate underneath the edges of the cloth and causing the cloth to flap in the wind leading to further tearing. These prior art devices are not only time consuming to deploy but are difficult to remove and reposition.

### BRIEF SUMMARY OF THE INVENTION

In accordance with this invention, a flexible sheet of vapor-permeable ground-cloth or landscaping film or fabric is provided having reinforced edges and openings for garden plants. The edges of the sheet include weighted portions that hold the sheet in place to prevent movement by wind and to minimize sunlight intrusion under the edges of the sheet. A flexible, porous watering tube is attached to the bottom of the sheet in proximity to the openings, preferably by utilizing flaps created by formation of the openings. When supplied with water via a garden hose or other source, the tube allows a controlled amount of water to drip through the wall of the tube onto the ground. Through gravity and capillary action, water enters surrounding soil and provides moisture to the garden plants. Weed growth is greatly restrained by blocking the covered ground from sunlight and providing a physical barrier to upward growth. Because the watering tube is positioned underneath the sheet, moisture is prevented from readily evaporating and is maintained at stable levels for improved plant growth.

Since the device inhibits evaporation, it greatly reduces the volume of water required to maintain a garden and is particularly beneficial in areas of drought or in other regions where water usage is controlled or otherwise restricted. Because the device restricts weed growth, its use is also particularly advantageous for organic gardening or farming since use of herbicides is not required. Plant disease and crop spoilage is greatly reduced without the use of antimicrobial applications or insecticides since the device blocks soil from splashing upward and onto leaves or fruit during rain or watering, a common source of disease organisms and promoter of insect infestation. Since use of the apparatus and system of the present invention minimizes crop contact with soil, whether through splashing or resting on the ground, fruits and vegetables tend to remain relatively clean and may be harvested and stored without cleaning.

Movement or dislocation of prior art devices is typically restricted through use of staples or stakes pushed through the fabric or sheet material of the prior art device itself. Although laborious to install and remove, without such elements the prior art devices are subject to dislocation, primarily through action of wind on the underside of the device. Dislocation occurs through action by wind on two portions of a prior art device not secured by staples or stakes or having the advantages of the present invention. First, wind may lift the outer edges of the cloth or fabric causing the edges to fold back or bunch, or lifting the entire device. Second, wind may enter planting spaces and cause the device to shift position. An unexpected advantage of the present invention is that retention of the device in the desired location is greatly enhanced by not only providing weighted edges at the periphery of the device but by the additional weight provided by the hose at the edge of each planting space. By providing additional weight at both locations, wind is inhibited from intruding beneath the outer edges of the device or becoming trapped by entering through the planting spaces. This system is particularly effective if the planting slots or holes are located inward of the hose. Since wind is directional, any wind that does enter a planting space may be immediately evacuated through spaces in the adjoining row.

Because the preferred sheet material is UV-resistant, the device may be left in place year-round. After crops have been harvested or flowers have ceased blooming, the plant growth within the provided planting spaces may be pulled or cut and the soil within the spaces turned by hand prior to replanting. If plants are cut at the root level, the roots will tend to decompose during the non-growing season, providing compost and nutrients to the soil within the planting spaces.

Alternatively, the device may be simply rolled or folded into a size convenient for carrying and storage at the end of the growing season. Soil amendments such as compost may then be tilled in as desired prior to re-use of the device.

### BRIEF DESCRIPTION OF THE DRAWINGS

FIG. 1 is an environmental perspective view of three weed barriers in accordance with the present invention situated in a garden with garden plants located within planting spaces and weeds occupying open adjacent ground;

FIG. 2 is a top plan view of a weed barrier in accordance with the present invention;

FIG. 3 is a bottom plan view of the device of FIG. 2;

FIG. 4 is an enlarged bottom view of a section of a weed barrier showing a planting slot and a section of porous hose held in place by a flap;

FIG. 5 is a cross-sectional view along line 5-5 of FIG. 4;

FIG. 6 is an enlarged bottom view of a portion of a weed barrier showing a planting hole and a section of porous hose held in place by a flap;

FIG. 7 is a cross-sectional view along line 7-7 of FIG. 6;

FIG. 8 is an enlarged bottom view of a planting hole of FIG. 3 detailing construction of flaps for retaining a T fitting;

FIG. 9 is a bottom view of the planting hole of FIG. 8 showing the flaps in place after attaching to the underside of the sheet;

FIG. 10 is a diagram illustrating initial steps in the formation of edge flaps;

FIG. 11 is a side view of a notched weight;

FIG. 12a is a diagram further illustrating the formation of edge flaps and edge pockets for retaining the weight of FIG. 11;

FIG. 12b is a partial bottom view showing edge flaps folded over and stitched in place to form edge pockets;

FIG. 13 is a partial bottom view of two alternative embodiments of the present invention illustrating methods for connecting the sheet material and hose fittings:

FIG. 14 is a perspective view of a female hose fitting projecting through an aperture in the edge of a weed barrier;

FIG. 15 is a top view of an embodiment of the present invention having two rows of planting holes;

FIG. 16 is a bottom view of another embodiment of the present invention having two rows of planting slots;

FIG. 17a is a partial cross-sectional view of an edge pocket and weight;

FIG. 17b is a partial cross-sectional view of an alternative edge pocket and weight;

FIG. 18a is a partial cross-sectional view of an edge pocket and weight;

FIG. 18b is a partial cross-sectional view of an edge pocket and weight with stitching passing through the weight material;

FIG. 19 is a partial cross-sectional view of another form of edge pocket and weight;

FIG. 20a is an enlarged view of the bottom surface of a corner portion of a weed barrier;

FIG. 20b is a plan view illustrating adjacent, perpendicular weights joined by an interconnecting notch and tab;

FIG. 20c is a view of the bottom surface of a corner portion of a weed barrier illustrating the position of interconnecting weights;

FIG. 21 is a diagram showing three weed barriers attached by overlapping weighted edges and connecting porous hoses;

FIG. 22 is a front elevation of a flow restrictor disk;

FIG. 23 is an exploded perspective of a gasket and flow restrictor aligned for insertion in a female hose fitting;

FIG. 24 is a side elevation of a conical flow restrictor;

FIG. 25 is a top view of the conical flow restrictor of FIG. 24;

FIG. 26 is a cross-sectional view of the conical flow restrictor along line 26-26 of FIG. 25, including environmental elements in cross-section with cross hatching omitted for clarity;

FIG. 27 is a perspective view of the conical flow restrictor of FIGS. 24 to 26;

FIG. 28 is a side elevation of an alternative embodiment of a conical flow restrictor;

FIG. 29 is a longitudinal cross-section of the conical flow restrictor of FIG. 28 oriented ninety degrees to the right and including environmental elements in cross-section with cross hatching omitted for clarity,

FIG. 30 is a top view of a circular weed barrier in accordance with the present invention;

FIG. 31 is a top view of another embodiment of a circular weed barrier in accordance with the present invention.

### DETAILED DESCRIPTION

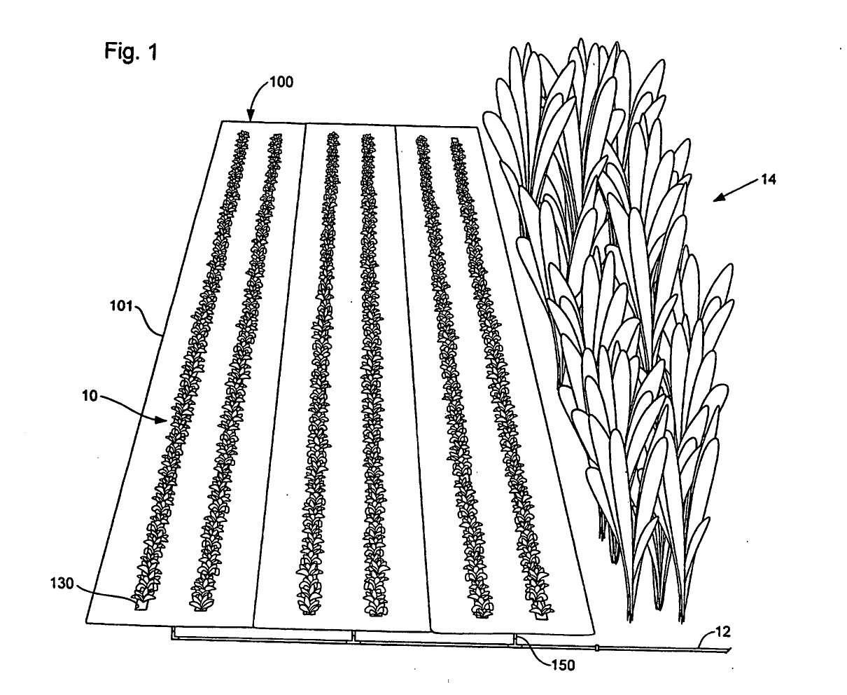

Turning more particularly to the drawings, FIG. 1 illustrates three identical weed barrier and garden watering systems 100 (hereinafter referred to as “weed barrier”), each in accordance with the present invention. The weed barriers 100 illustrated are of the type used with row crops and are shown positioned side-by-side in a typical garden setting. The weed barrier includes a sheet of vapor-permeable material 101 such as ground cloth or landscape fabric used in the horticulture industry. Openings, or planting spaces 130, are provided along the length of the sheet 101 to provide space for plants 10 to grow. As will be shown in detail in subsequent figures, water is supplied to the plants via one or more water-permeable tubes or hoses 150 attached to the underside of each weed barrier 100 to deliver water to garden plants 10 contained within the planting spaces 130. In the case of multiple weed barriers 100 as shown in FIG. 1, the permeable hoses 150 of each device may be linked together and attached to a water distribution means or supply which may include a common garden hose 12. In use, the weed barrier 100 is held in place by weights incorporated into the edges of each sheet 101. The device provides an effective barrier to weed growth as may occur on uncovered ground (see 14, FIG. 1), as well as an effective method of watering garden plants.

The sheet material 101 is preferably formed from a UV-stabilized polymer film that has been perforated to allow moisture and air to pass through, or from a single or multiple layer of UV-resistant, woven or non-woven textiles. Examples of suitable sheet material include woven or non-woven UV-resistant polypropylene landscape fabric, non-woven fabric formed of felted fibers of UV-resistant polyethylene, or spun bond UV resistant polypropylene.

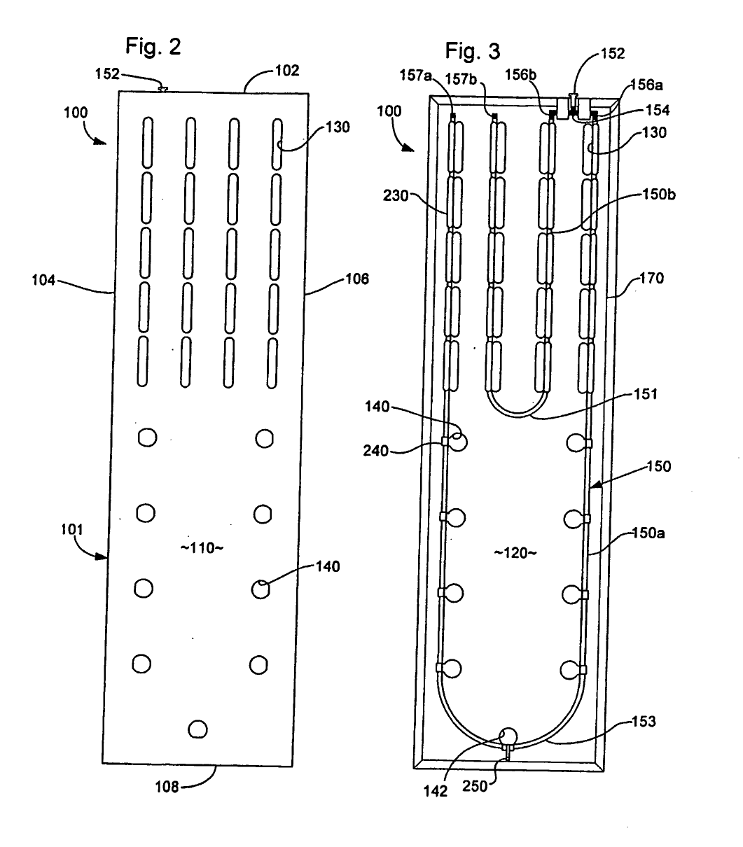

FIGS. 2 and 3 illustrate top 110 and bottom 120 surfaces, respectively, of an embodiment of the present invention designed to accommodate a variety of garden plants. As illustrated, the weed barrier 100 is formed from a sheet 101 of landscape fabric 48 inches wide and 168 inches long. The edges of the sheet 101 are reinforced to prevent tearing of material during use and to provide a resilient structure to house weights and optional fastening holes.

The weed barrier illustrated in FIGS. 2 and 3 includes rows of spaced planting slots 130 for planting small row crop vegetables such as radishes, lettuce, carrots, beets, spinach, onions, etc. Nine widely spaced planting holes 140 are also provided for planting larger vegetables such as peppers, eggplant, broccoli, etc. Four rows of five planting slots 130 each provide 20 feet of planting space for row crops. The planting slots 130 are optimally 12 inches long and 2 inches wide. In each row, 1 inch of material is left between the ends of each adjacent planting slot 130 to structurally define the individual slots and to prevent excessive spreading of the sides of the slot beyond the optimal width of 2 inches. As shown, the planting holes 140 are approximately 4 inches in diameter. FIG. 2 shows a top view of the device 100 as viewed when in place including a water inlet 152 for supplying the porous hose 150 attached to the bottom surface 120 of the sheet material 101.

FIG. 3 is a bottom view of the weed barrier 100 shown in FIG. 2. This particular embodiment includes a single water inlet 152, which may comprise a common female garden hose fitting and a water restrictor (not shown), attached to a tubular T fitting 154 for directing water to two flow paths. Two tubular L-shaped fittings 156a and 156b are attached to the outlets of the T fitting 154, one on either side. As shown in the drawing, a relatively long portion 150a of porous hose 150 is attached to the right L-shaped fitting 156a and substantially transverses the perimeter of the weed barrier 100. A shorter length 150b of the porous hose 150 is attached to the left L-shaped fitting 156b and forms an inner loop 151 to supply water to the two inner rows of planting slots 130. The end of each hose distal from the aforementioned fittings is closed using a plug 157a and 157b, a hose fitting and cap, or other means such as heat-sealing, to prevent water from escaping out the otherwise open ends. The hose 150 may be secured to the bottom of the weed barrier 100 by using flaps 230 and 240 created during the formation of the planting spaces 130 and 140 (see FIGS. 5 and 7).

Preferably, any fittings, plugs or other devices connected to the hose 150 are formed from a corrosion resistant material such as plastic or brass. Fittings and plugs may include secondary elements such as clips, bands or other materials necessary to secure the hose 150 to the fitting when subjected to water pressure, particularly in the case where the hose 150 fits over the outside of the fitting. It is preferable to use barbed “outside” fittings because such secondary elements are not required and, since the hose fits inside the fitting, there is little or no restriction in the flow of water through the fitting. This type of fitting is often referred to as “full flow” since the flow path is not restricted by a decrease in internal diameter from that provided by the attached tube or hose.

The porous hose 150 may be one similar to those known in the art as soaker hoses, but should be sufficiently flexible to allow ease of folding of the device 100 for storage. Preferable internal dimensions for the porous hose 150 are from ⅜ to ⅝ inches. Typically, such hoses are formed from ground, recycled rubber and/or virgin natural, synthetic or thermoplastic rubber mixed with polyethylene or other binder plastics. The walls of a suitable porous hose 150 weep or sweat water through labyrinth passages formed during extrusion. Preferably, the selected hose 150 drips water from its outer surface rather than propelling water off the surface in small jets. Steady, low-pressure application of water, distributed to the plants 10 via capillary action through the soil, can thereby maintain a constant moisture level throughout the area covered by the device 100.

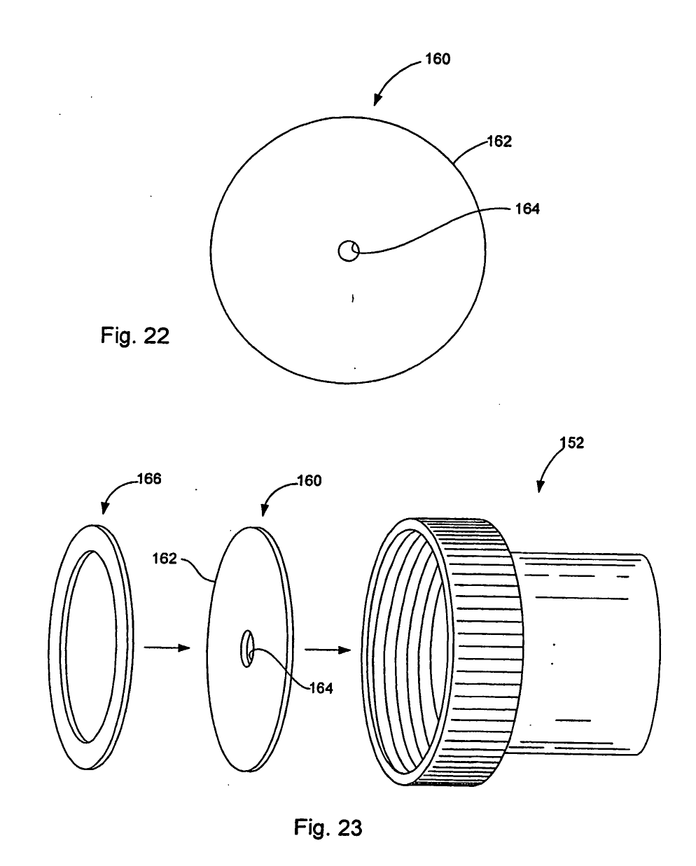

Flow restrictors 160 (see FIGS. 22 to 29) may be used to reduce and regulate flow from the water supply through the porous hose 150. An effective flow restrictor 160 may consist of a flat plastic disk 162 of an external diameter sized to fit inside a female hose fitting 152, as illustrated in FIGS. 22 and 23. A hole 164 in the center of the disk 162 is sized to the internal diameter necessary to restrict flow as required for a particular application. An effective internal diameter of hole 164, for use with a 50 foot length of ⅝ inch internal diameter porous hose 150, is approximately 0.075 inches, depending on soil texture and consistency. After inserting the flow restrictor 160 into the female hose fitting 152 (see FIG. 23) a common hose gasket 166 is installed in the normal fashion thereby securing the restrictor 160 in place and providing means for a water tight seal.

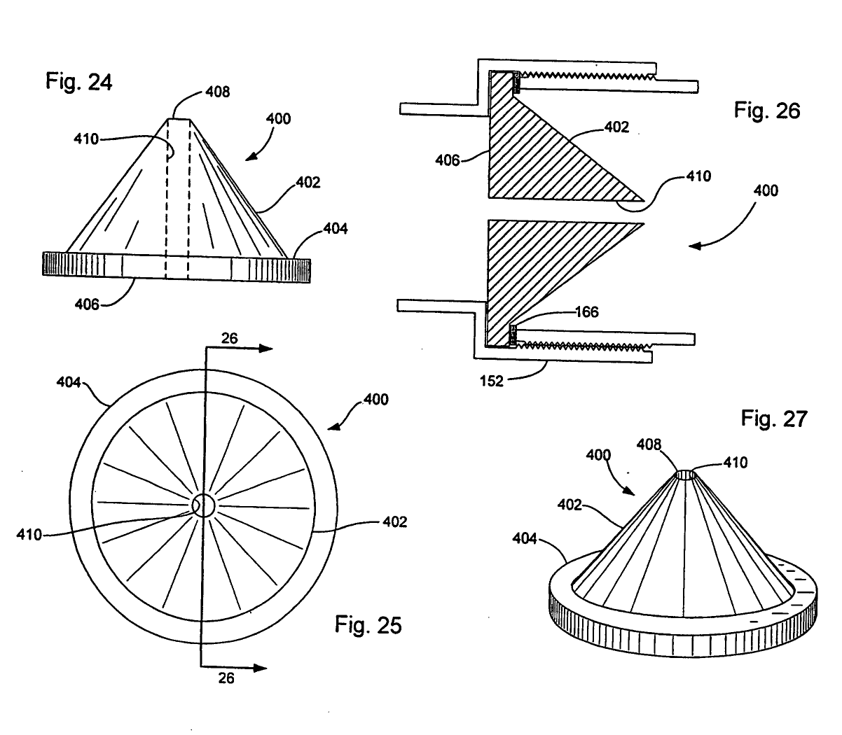

Another effective flow restriction device is illustrated in FIGS. 24 to 27. The device illustrated is a conical flow restrictor 400. This conical flow restrictor 400 comprises a solid cone 402 having a flange 404 projecting from the base 406 of the cone and an axial bore 410 through the longitudinal center of the device 400. In use, the conical flow restrictor 400 is placed inside a female hose fitting 152 with the narrow end or tip 408 of the cone pointed in the direction from which water traveling through the hose will flow. After inserting the conical flow restrictor 400 into the female hose fitting 152 a common hose gasket 166 is installed over and around the cone 402 so that it rests against the flange 404 thereby securing the restrictor 400 in place and providing means for a water tight seal between the male and female hose fittings.

The bore 410 is sized to the internal diameter necessary to restrict flow as required for a particular application. Due to the elongated channel formed by the bore 410, and the concomitant increase in flow resistance or drag (hydrodynamic turbulence and friction) caused by water flowing past the channel walls, the diameter of the bore 410 may be increased from that of the hole 164 in the disk-shaped flow restrictor illustrated in FIGS. 22 and 23. An additional advantage of this restrictor 400 is that the sloping surface of the cone 402 tends to deflect debris in the water flow away from the bore 410. This reduces the likelihood, relative to the hole 164 in the flat plastic disk 162, of the bore 410 clogging.

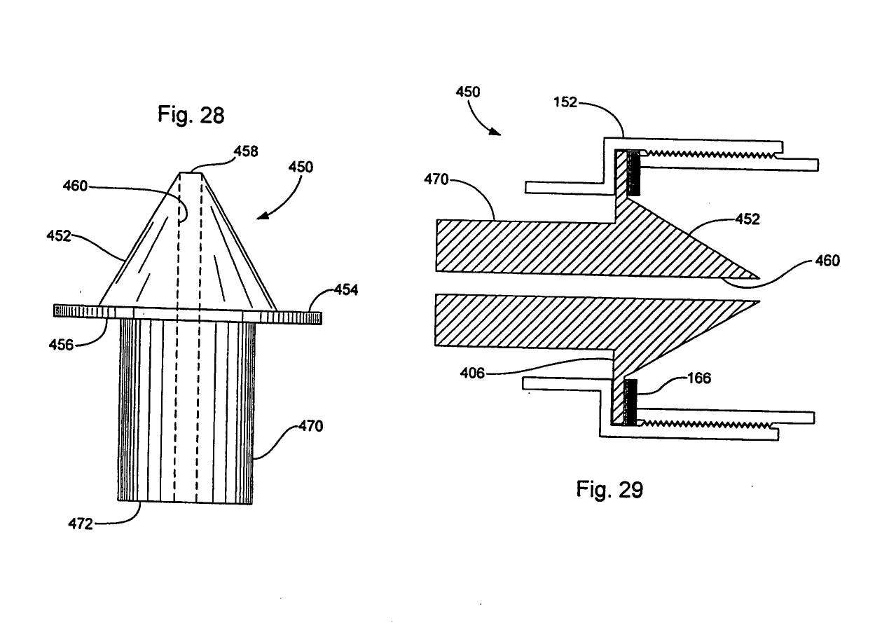

FIGS. 28 and 29 illustrate a further embodiment 450 of a conical flow restrictor including a solid cone 452 having a flange 454 projecting outward, perpendicular to the longitudinal axis of the device, from the wide end 456 of the cone, a barrel 470 projecting longitudinally from the wide end 456 of the cone 452, and a channel or aperture 460 passing through the longitudinal center of the device 400 from narrow tip 458 of the cone to the end 472 of the barrel 470.

As with the conical flow restrictor 400 of FIGS. 24 through 27, the elongated channel formed by the aperture 460, and the resulting increase in resistance to water passing through the restrictor 450, may allow the diameter of the aperture 460 to be increased.

The conical flow restrictor of FIGS. 28 and 29 also illustrates that dimensions of the cone 452 and flange 454 may be varied to suit a particular application. For example the base of the cone 452 has been narrowed, and the width of the flange 454 thereby increased, to accommodate a larger hose gasket 166 and to illustrate dimensions that would allow the restrictor 450 to be reversed in position relative to the hose fittings 152.

In addition to the flow restrictors illustrated herein, other devices may be used to control the flow of water to the porous hose 150, such as ball valves, pressure regulators, flow controllers, flow meters, or other devices known in the prior art.

It should be appreciated that a weed barrier 100 of any practical dimensions may be constructed to satisfy the requirements of a given application. The number of planting slots may be varied as required as may the number of planting holes. Either planting slots or planting holes may be used exclusively or in combination for a given application. The width between rows or individual planting spaces may be varied as required for the particular vegetation to be planted. Single row planting spaces may be centered or off-set on any width of weed barrier. Minimal experimentation may be required using flow restrictors 160 of varying internal diameters or flow levels to assure appropriate wetting of the soil along the length of the device 100.

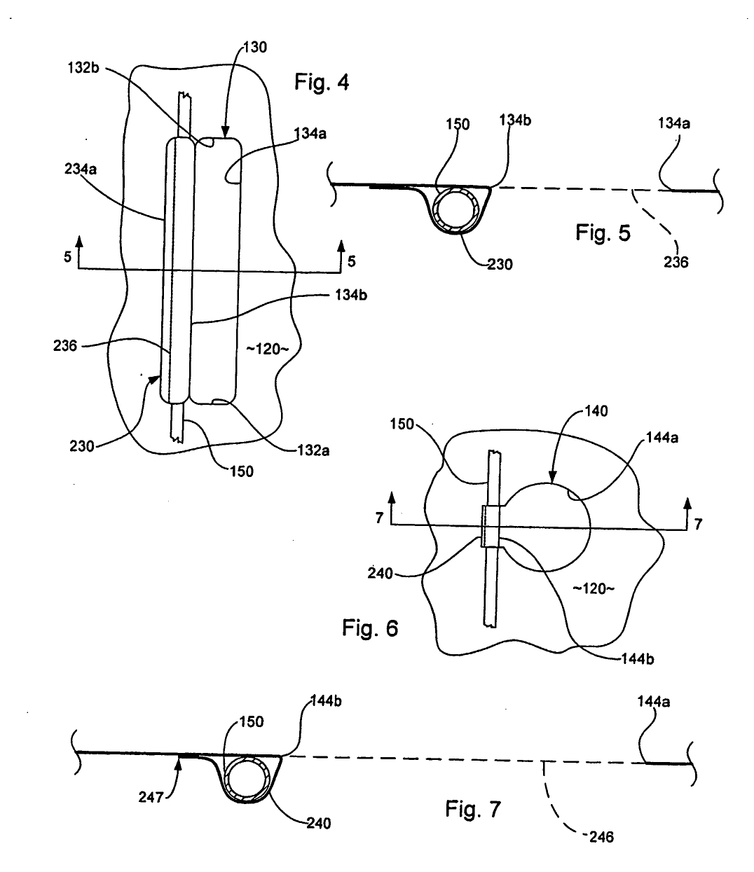

FIGS. 4 through 9 illustrate the formation of the planting slots 130 and holes 140 and the associated formation of flaps 230 and 240 or tubes used to house and attach the porous hose 150 to the underside 120 of the sheet material 101. It should be appreciated that the openings which form the planting slots 130 and holes 140 may be of various shapes but are preferably substantially rectangular for use with row crops or flower rows, and substantially circular for single plantings, particularly of large vegetables or bushes. The rectangular planting slot 130 shown in FIG. 4 includes relatively short ends 132a and 132b approximately 2 inches wide and relatively long sides 134a and 134b approximately 12 inches long. A planting slot 130 is formed by cutting the ends 132a and 132b of each slot as well as the long side 134a furthest from the porous hose. The cut side edge 234a is then folded back upon the underside 120 of the sheet 101 and sewn with UV-resistant thread or otherwise secured in place (see dashed line 236) to form a tube 230 for holding the porous hose 150 next to the planting slot 130. Other methods of securing the tube 230, such as adhesive, heat bonding, or double-sided adhesive tape may be used. The required size of the tube 230 may vary depending on the external diameter of the porous hose 150 utilized. FIG. 5 provides a cross-sectional view along line 5 of FIG. 4 showing side edges 134a and 134b of the planting slot 130, a flap 230 formed by cutting side edge 134a and ends 132a and 132b, and a porous hose 150 housed within a tube formed by sewing the flap 230 in place. The dashed line 236 indicates the planting space created when the flap 230 is folded over. Typically, a porous hose 150 having an internal diameter of ⅜ to ⅝ inch will be used. A hose 150 having an internal diameter larger than ⅝ inch may require the planting slot 130 to be wider than 2 inches. This wider slot, however, would tend to permit increased water evaporation and weed growth within the slot.

FIGS. 6 and 7 illustrate the formation of a planting hole 140. A circular cut 144a is made at a predetermined position proximate or adjacent to a section of porous hose 150. As the circular cut is made, a portion of the circle 144b proximate the porous hose 150 is left attached and uncut. The resulting flap 240 is folded over in a manner similar to that described earlier for planting slots 130 and sewn in place to form a tube for holding the porous hose 150. Due to the larger diameter of the planting holes 140 relative to the planting slots 130, a portion of the flap 240 is typically trimmed off and discarded. FIG. 7 is a cross-sectional view along line 7 of FIG. 6 showing the flap 240 formed by cutting a planting hole 140, trimmed and attached to the underside 120 of the sheet material 101 to form a tube for holding the porous hose 150. The dashed line 246 in FIG. 7 indicates the space created when the flap 240 is folded over. The arrow 247 in FIG. 7 indicates where excess flap 240 material has been trimmed.

A device of the present invention may be configured so that additional units may be attached one to another to increase the garden space provided. As illustrated in FIG. 3, the planting hole 142 located on the opposite side and at the bottom of the outer curve 153 of the porous hose 150 is adjacent a plastic tubular T fitting 250 connecting segments of the larger hose 150a. The outlet of the T fitting 250 may remain plugged or otherwise closed until needed to supply water to an adjacent weed barrier 100. At that time, the plug may be removed from the outlet of the T fitting 250 and a male fitting may be attached which will provide a connection to the female fitting of an adjacent weed barrier so that water may be supplied.

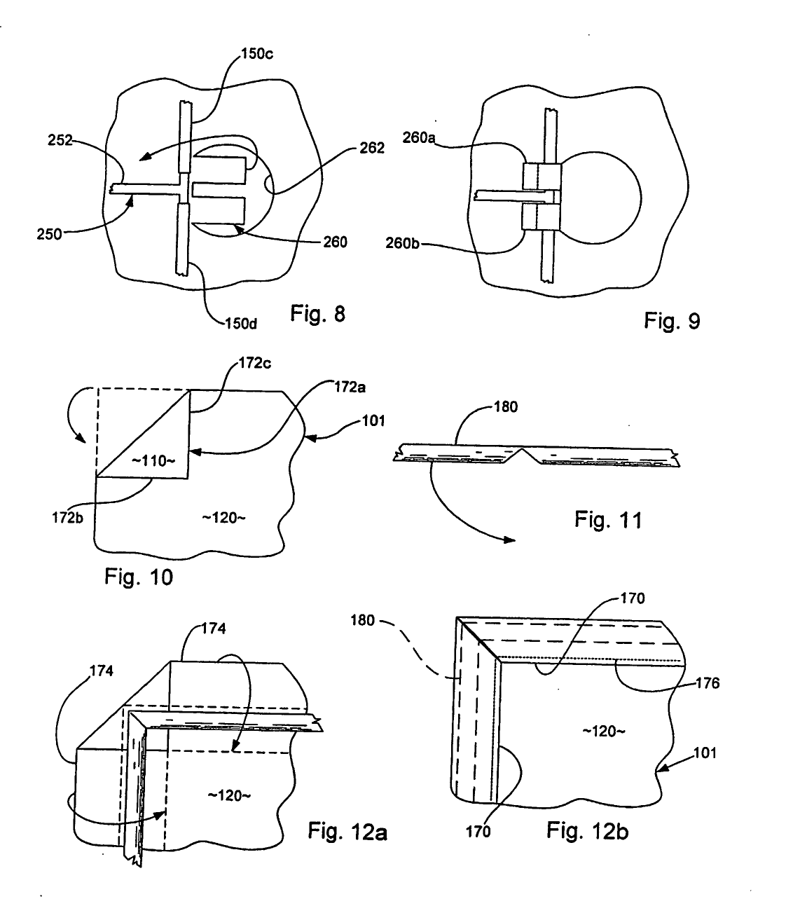

FIGS. 8 and 9 demonstrate a method of creating a specialized flap 260 for use in securing a T fitting 250 and attached sections of hose 150c and 150d to the underside 120 of the weed barrier 100. A partial circular cut 262 is made in the sheet material 101 adjacent to where the T fitting 250 is to be secured. From the flap created, two smaller rectangular flaps 260a and 260b are cut, folded over and sewn in place, one on either side of the outlet portion 252 of the T fitting 250.

It should be appreciated that other methods may be utilized for holding a porous hose 150 in place on the underside 120 of the weed barrier 100, including cable ties or plastic coated wire threaded through the sheet material 101 and around the hose 150. The methods and materials illustrated in FIGS. 2 through 9, however, provide an efficient method of creating planting slots 130 and holes 140 concurrent with flaps 230 and 240 or tubes for holding a porous hose 150 in place. No extra material is required to secure the porous hose 150 other than that formed as a result of cutting the planting slots 130 and holes 140.

FIGS. 10 through 12b illustrate the formation of edge pockets 170 for holding weights 180. Weights 180 are distributed along the edges of the weed barrier to provide a means of holding a barrier 100 in place in replacement of wire staples or stakes used by devices in the prior art. Initially, a corner 172a of the sheet material 101 is folded under (see arrow in FIG. 10) so that the inward edges 172b and 172c of the triangular flap formed are each 4 inches wide (FIG. 10). The weight 180 may then be bent, if pliable, to form a right angle and positioned as indicated in FIG. 12a—near the outer edges of the sheet material 101. If the weight 180 is difficult to bend it may be notched to assist bending (see FIG. 11), or severed and the ends placed in close proximity to one anther. A 2-inch wide flap 174 is then folded inward around the perimeter of the sheet 101 (see FIG. 12a) and stitched (see dashed line 176) or otherwise held in place to form an open tube or pocket for holding the weight 180 (see FIG. 12b). Although suitable attachment means include use of adhesive or heat bonding, experimentation has revealed that sewing with UV-resistant thread is preferable as a replacement, or to augment, other attachment means. The width of the flap 174 may vary, depending on the size and shape of the weights 180. As an alternative to folding over corner 172a, as shown in FIG. 10, the corner material may simply be removed and flaps 174 folded as described above.

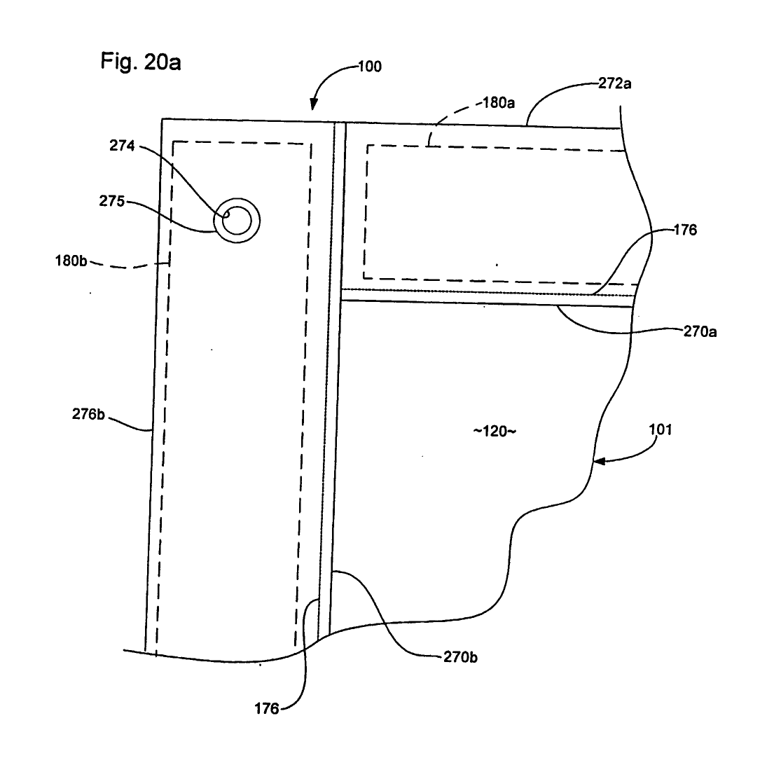

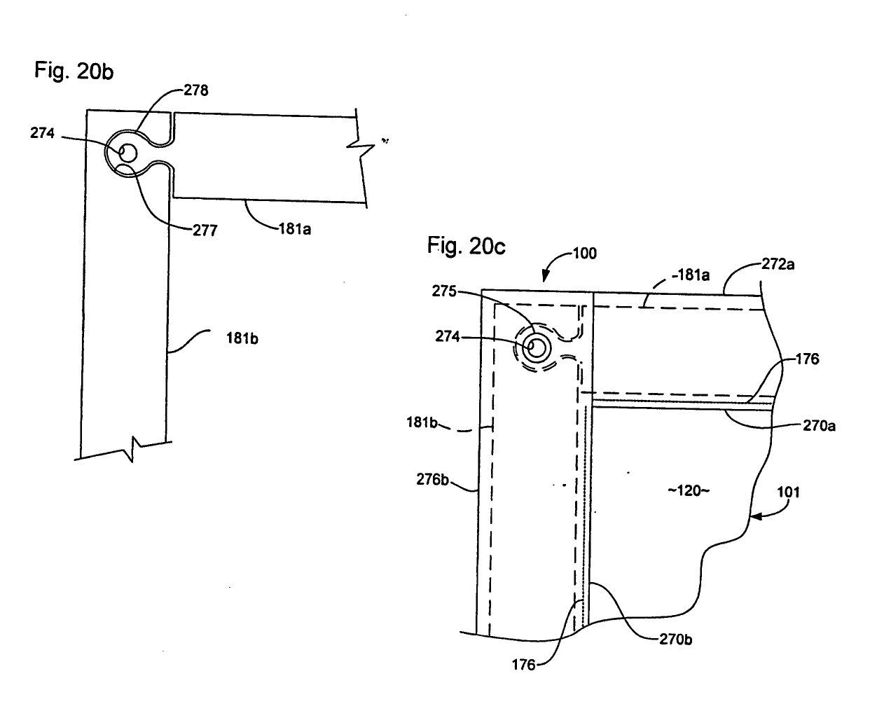

FIG. 20a illustrates a corner portion of an alternative embodiment of a weed barrier 100 having reinforced edges and edge pockets 270a and 270b of a type that may be used if weights 180a and 180b for adjacent edges 272a and 272b are not connected or formed from the same piece of weight material. A weight 180a is placed approximately 2 inches inward from, and in alignment with, an outer edge of the sheet material 101. A 2 inch wide flap 270a is then folded over and sewn 176 or otherwise fixed in place. A second weight 180b is placed approximately 2 inches inward from, and in alignment with, the adjacent, perpendicular edge of the sheet material 101. A second 2 inch wide flap 270b is folded over and also fixed in place. One of the weights 180 may be provided with a hole 274 that also penetrates the overlying sheet material 101.

Suitable weights 180 include materials such as metal, rubber, plastic and sand. Rigid material such as metal should be segmented to allow for folding of the weed barrier for shipping and storage, and to allow the device to conform to the surface of the ground when in place. The weights 180 are preferably fixed into pockets 170 in the sides of the device 100 during manufacturing but may be provided separately and installed by the end user by sliding into provided edge pockets 170. Tubular rubber or plastic work well for weighting as both are flexible and will tend to conform to the surface of the soil.

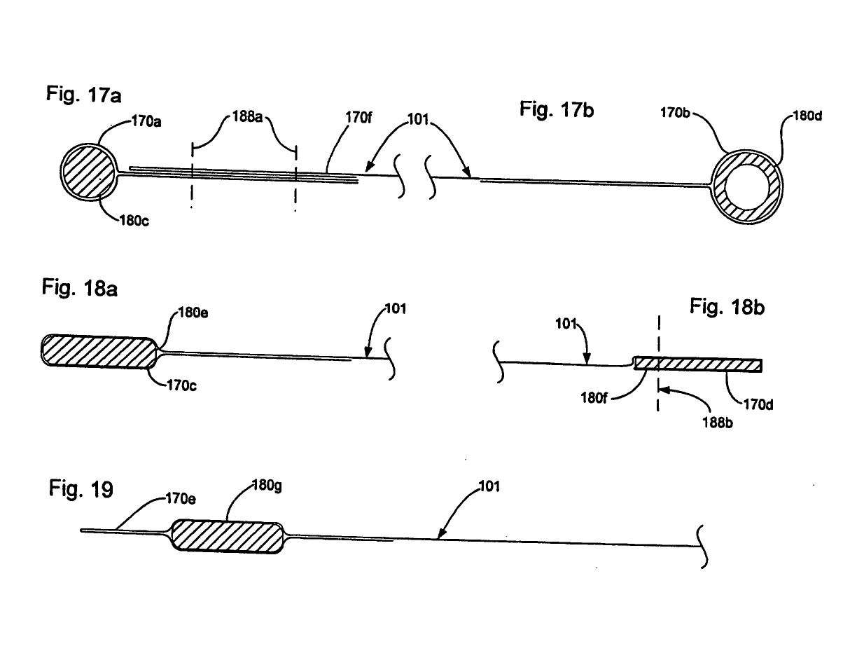

FIGS. 17, 18 and 19 show cross-sections of different types of weights 180 installed in different embodiments of edge pockets 170. As shown, the edge pockets 170 may be dimensioned as required to provide adequate space for the selected weight material 180. FIG. 17a shows an alternative embodiment wherein a solid cylindrical weight 180c is enclosed within a pocket 170a formed from a separate strip of sheet material. The pocket 170a is then attached to a doubled edge 170f of the sheet material 101. Means for attaching pocket 170a to edge 170f include double stitching with UV-resistant thread. Placement of stitches is indicated by dashed lines 188a. FIG. 17b shows a tubular weight 180d, such as a rubber or plastic tube, enclosed in edge pocket 170b, formed by folding over the edge of the sheet material 101 to enclose the weight 180d.

In FIG. 18a the weight 180e is a bar material such as rubber or metal and is disposed to the outer edge of the edge pocket 170c. Preferable cross-sectional dimensions for rubber bar material range from ⅛ by 1 inches to ¼ by 1 ½ inches. In FIG. 18a the approximate dimensions of the weight 180e are ¼ by 1 inches.

FIG. 18b illustrates a weight 180f, approximately ⅛ inches thick and approximately 1 inch wide, enclosed in pocket 170d and sewn in place by stitching through the weight 180f itself. As illustrated, stitching is be set back approximately ¼ inch along the longitudinal edge of the weight 180f, opposite the outer edge of the weed barrier, as indicated by dashed line 188b.

In FIG. 19 the weight 180g is disposed toward the center of the edge pocket 170e. Means for securing the edge pockets illustrated in FIGS. 17a through 19 include use of adhesive, heat bonding, double-sided adhesive tape, or sewing or stitching with UV-resistant thread. Single or multiple lines of stitching may be used as necessitated or desired.

FIGS. 20b and 20c illustrate an improved method for attaching and stabilizing perpendicularly adjacent weights 181a and 181b. One of the weights 181b is provided with a notch 277 that is shaped to fit and substantially surround a corresponding tab 278 on an adjacent weight 181a. Preferably, if a hole 274 is provided, it is located in the center of the tab 278. The tab 278 and notch 277 lock together to keep the adjacent weights 181a and 181b attached, while allowing motion around joint. FIG. 20c illustrates the weight arrangement of FIG. 20b when in place within the sheet material 101 of a barrier 100. Hidden features such as the weights 181a and 181b are shown in large dashed lines. Small dashed lines indicate stitching 176.

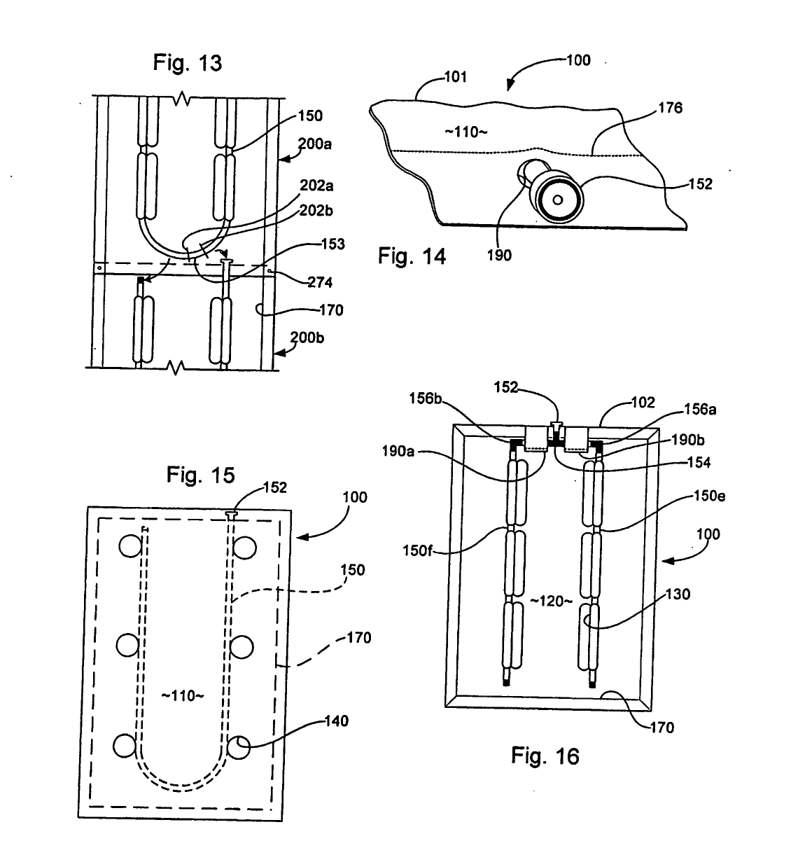

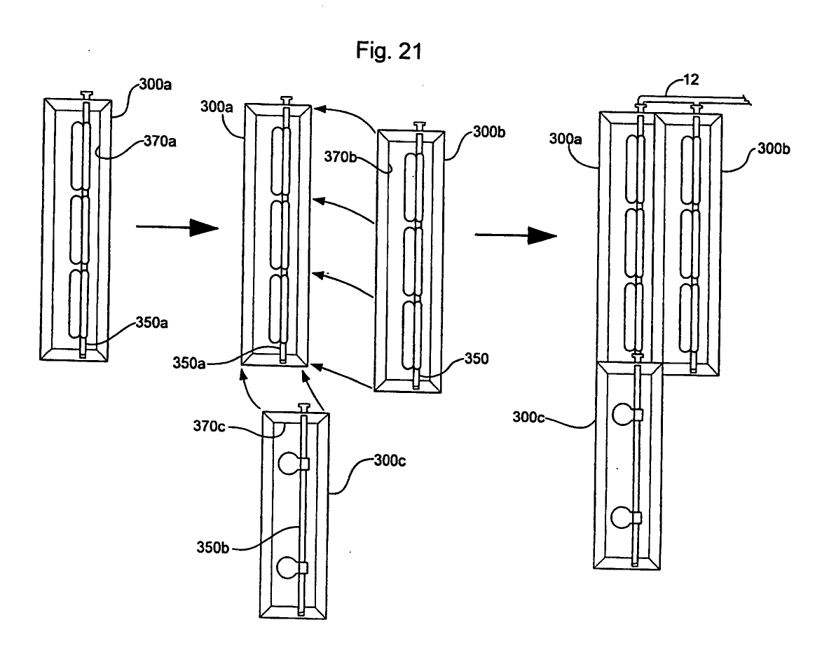

As shown in FIGS. 13 and 20a through 20c, holes 274 may be formed in the reinforced edges of a weed barrier 100 to accept stakes (not shown) for use in particularly hostile wind conditions or to facilitate coupling adjacent devices 200a and 200b (see FIG. 13). Grommets 275, preferably formed of corrosion-resistant material such as plastic or brass, may be installed to strengthen the sheet material surrounding a hole 274. Because of the weighted edges 170 provided by the present invention, stakes are not normally required to hold a device of the present invention in place. In addition, merely overlapping the weighted edges 170 of adjacent devices satisfactorily holds the devices in place under typical conditions. FIG. 21 illustrates how, for example, relatively small, single-row embodiments 300a, 300b and 300c of the device may be easily joined by overlapping the weighted edges 370a, 370b and 370c, connecting porous hoses 350a and 350b in series and connecting the devices to a common water supply 12.

FIG. 13 also illustrates an alternative method to that described above (see the discussion of T fitting 250) for joining the porous hoses 150 of adjacent devices 200a and 200b. Where no planting slot 130 or hole 140 is located adjacent to the section of porous hose 150 nearest the edge opposite the water inlet (see 153, FIG. 13), that section of hose may be readily cut (see lines 202a and 202b indicating locations of cuts) and the remaining ends fit with common garden hose fittings to connect to an adjacent device 200b. As an alternative to a connection using typical garden hose fittings, hoses of adjacent barriers may be attached by cutting off the existing fittings or plugs and connecting the ends of the hoses by connectors as described previously.

The fitting 152 provided for delivery of water to the porous hose 150 may be located underneath the weed barrier 100 (see FIG. 15), project from underneath the weed barrier 100 (see FIGS. 2, 3, and 16), or, alternatively, an aperture 190 may be provided as illustrated in FIG. 14, so that the fitting may rest upon the edge of the sheet material 101 thereby providing easier access for coupling and some protection to the fitting 152 from soil and grit. FIG. 15 is a top view of a weed barrier 100 utilizing the aperture and fitting 152 placement of FIG. 14. The porous hose 150 and folded-over edges 170 of the sheet material 101, located on the underside of the device, are shown in dashed lines for reference. FIG. 15 also illustrates that the present invention may be practiced using only planting holes 140, as opposed to both holes 140 and slots 130 as shown in FIGS. 2 and 3, and that a two row configuration may be served by a single, looped section of porous hose 150. The device 100 illustrated in FIG. 15 is particularly advantageous for growing mid-sized vegetables such as broccoli, eggplant, and peppers.

FIG. 16 illustrates a bottom view of a weed barrier 100 in accordance with the present invention having two relatively short rows of planting slots 130. In this embodiment, the rows are served by separate sections of porous hose 150e and 150f joined at the inward end via L-shaped, or angled, tubular fittings 156a and 156b connected to a tubular T connector 154. As well as illustrating the T configuration used with a relatively simple two-row device 100, FIG. 16 shows the folded corners described in detail above and the flaps 190a and 190b that may be formed for securing the T 154 and L 156a and 156b fittings in place. It may be appreciated that in order to form flaps 190a and 190b, extra sheet material must be either attached to the inward edge of the device 100 or provided when the sheet 101 is initially cut to shape. As an alternative to flaps 190a and 190b, small holes (approximate diameter ⅛ inch) may be formed on either side of fitting 152 (or attached portion of hose 150 or T 154) and threaded with cable ties (not shown) or plastic-coated wire (not shown) to secure fitting 152 to the adjacent sheet material 101. If used, plastic cable ties are preferably formed of UV-resistant material.

Although the device 100 in FIG. 16 does not utilize the hose placement of FIG. 14, an aperture could be formed between the end flaps to accommodate placement of the hose fitting 152 on the top surface 110 of the sheet material 101 (see FIG. 14). The embodiment illustrated in FIG. 16 is particularly advantageous for growing small vegetables planted in rows such as radishes, lettuce, carrots, beets, and onions.

FIGS. 15 and 16 also demonstrate that the present invention may be practiced by devices substantially shorter than that disclosed in FIGS. 2 and 3, that the device may incorporate either planting slots 130 or planting holes 140 exclusively, and that, as shown in FIG. 15, the planting spaces 130 and 140 may be located to the outside as well as the inside of the porous hose 150. It is preferable, however, that the planting spaces 130 and 140 be located inward of the hose 150. Since wind is typically directional, any wind that enters a planting space can evacuate through spaces in the adjoining row without being trapped.

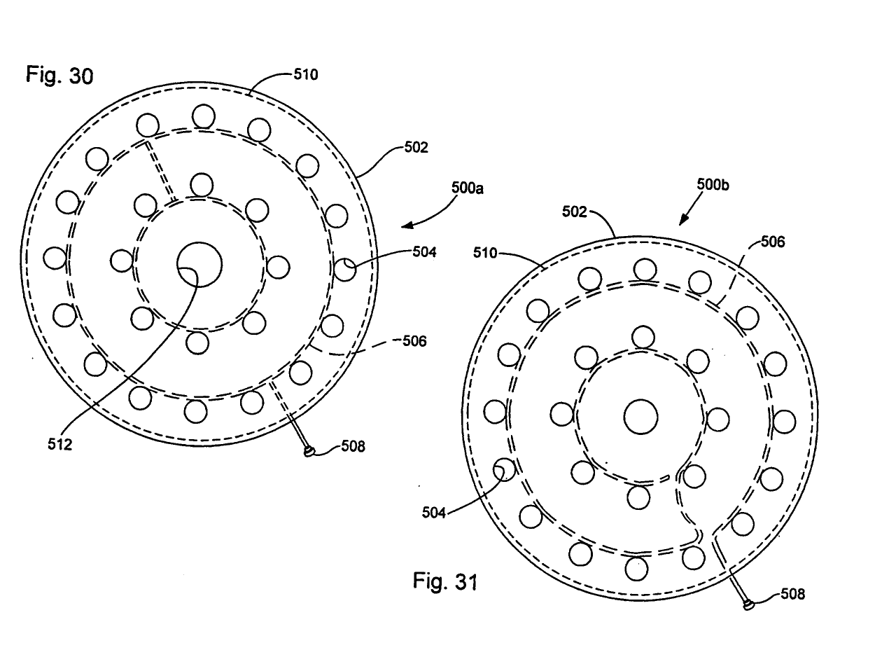

FIG. 30 illustrates one embodiment of a circular weed barrier 500a in accordance with the present invention. It includes a circular sheet 502 of vapor-permeable material. The outer margin of the sheet 500a is folded over and secured with stitches 510 or other means to form a reinforced edge and pocket for holding weighted material. A porous hose 506 is secured to the lower surface of the device 500a at a suitable distance from the outer margin. Planting spaces, such as slots, or the holes 504 illustrated, are formed in the sheet 502 in proximity to the hose 506. The hose 506 may be formed into interconnected concentric circles, as illustrated in FIG. 30, or may comprise a single length of hose looped in a circular fashion as in the embodiment 500b illustrated in FIG. 31. The water inlet 508 may project from underneath the sheet 502 as shown or be otherwise located as described above.

It should be appreciated that multiple units of the kinds shown in the Figures may be linked together to provide the garden configuration desired by the end user. To provide both relatively narrow rows and relatively wide rows in the same garden, devices of various widths may be connected. To determine the width of individual devices used in such an arrangement necessary to obtain the desired row width, the following steps may be followed using a single row device, as shown in FIG. 21. First, determine the desired distance between two adjoining rows and select a device having a width less than the desired row width. Next, subtract the distance from the center of the row of the selected device to its edge. Add the width of the reinforced edge (typically 2 inches). Multiply the result by a factor of 2. The amount calculated represents the required width of an adjoining unit to achieve the desired row width.

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is as follows:

1. A garden weed barrier and watering apparatus comprising:
flexible sheet of vapor-permeable material, said sheet having reinforced outer edges and openings in said sheet for garden plant stems to extend therethrough;
means for weighting said edges to secure said sheet to the ground; and
fluid-permeable tube secured to a lower surface of said sheet for delivering fluid to ground proximate to garden plants.

2. The garden weed barrier and watering apparatus of claim 1 wherein said sheet comprises a non-woven polymer film.

3. The garden weed barrier and watering apparatus of claim 1 wherein said sheet comprises a perforated sheet or a woven or non-woven textile material.

4. The garden weed barrier and watering apparatus of claim 1 wherein said sheet comprises felted fibers of thermoplastic material.

5. The garden weed barrier and watering apparatus of claim 1 wherein said edges are reinforced by double layers of said sheet secured by means selected from the group consisting of adhesive, tape, stitching, and heat bonding.

6. The garden weed barrier and watering apparatus of claim 1 wherein said edges have holes therein for accepting stakes or staples to provide additional retention of said apparatus against the surface of the ground.

7. The garden weed barrier and watering apparatus of claim 1 wherein said openings are substantially rectangular.

8. The garden weed barrier and watering apparatus of claim 1 wherein said openings are arranged in one or more substantially parallel rows.

9. The garden weed barrier and watering apparatus of claim 1 wherein said openings are substantially circular.

10. The garden weed barrier and watering apparatus of claim 1 wherein said means for weighting is selected from the group consisting of metal bars, metal tubes, rubber bars, rubber tubes, plastic bars, plastic tubes, metal cable, rope and sand.

11. The garden weed barrier and watering apparatus of claim 1 wherein said sheet is substantially opaque.

12. The garden weed barrier and watering apparatus of claim 1 wherein said openings are arranged in one or more concentric rings.

13. The garden weed barrier and watering apparatus of claim 1 wherein said tube further comprises means for restricting flow of fluid therethrough.

14. The garden weed barrier and watering apparatus of claim 13 wherein said means for restricting comprises a flat plastic disk positioned within said tube and of sufficient external diameter to occlude flow of fluid through said tube, said disk further comprising an aperture in the center of said disk.

15. The garden weed barrier and watering apparatus of claim 13 wherein said means for restricting comprises a conical flow restrictor comprising a cone having a flange projecting from the base of said cone and an axial bore through the longitudinal center of said conical flow restrictor.

16. A garden weed barrier and watering apparatus comprising:
landscape fabric having edge portions weighted to retain said fabric in a selected position upon the ground,
openings within said fabric for receiving garden plants, and
a water-permeable tube attached to the underside of said fabric.

17. The garden weed barrier and watering apparatus of claim 16 wherein said tube has segments thereof attached in close proximity to corresponding openings.

18. The garden weed barrier and watering apparatus of claim 16 wherein said edge portions comprise weights secured within edge pockets.

19. The garden weed barrier and watering apparatus of claim 17 wherein said openings are partially defined by respective portions of said tube.

20. A method of gardening whereby weeds are suppressed through obstruction of sunlight, and fluids are delivered to garden plants via a conduit, the method comprising the steps of:
providing an opaque vapor-permeable sheet having weighted outer edges and having openings for garden plants to extend therethrough,
attaching a fluid-permeable conduit to the underside of the sheet,
applying the sheet to an area of ground, and
directing water to the conduit for flow therethrough at intervals selected for encouraging plant growth.
